(19) United States
(12) Patent Application Publication
(10) Pub. No.: US 2020/0250736 A1
(43) Pub. Date: Aug. 6, 2020

(54) SYSTEMS, METHOD AND APPARATUS FOR FRICTIONLESS SHOPPING

(71) Applicant: Adroit Worldwide Media, Inc., Aliso Viejo, CA (US)

(72) Inventors: Kevin Howard, Aliso Viejo, CA (US); Kurtis Van Horn, Aliso Viejo, CA (US); Emad Mirgoli, Aliso Viejo, CA (US); Greg Schumacher, Aliso Viejo, CA (US); Steven Dabic, Aliso Viejo, CA (US)

(21) Appl. No.: 16/268,436

(22) Filed: Feb. 5, 2019

(51) Int. Cl. G06Q 30/06; G06K 9/00; G06Q 20/40

(52) U.S. Cl. CPC G06Q 30/0635; G06K 9/00664; G06Q 20/40145; G06K 9/00369

(57) ABSTRACT

In one embodiment, a frictionless shopping system is disclosed. The frictionless shopping system may include a plurality of intelligent shelving units having inventory cameras, customer recognition cameras, shelves configured to hold inventory, and one or more processors communicatively coupled to the plurality of intelligent shelving units. A non-transitory computer-readable medium coupled to the one or more processors and having logic thereon may be included. The logic can be configured to receive images captured by the customer recognition cameras, perform customer recognition techniques on the images, determine the location of customers within a pre-determined area, generate customer probability data based on the customer locations, receive images captured by inventory cameras, performing inventory detection techniques on the images, determining the location of inventory products within the pre-determined area, generating inventory probability data based on the inventory location determination, and utilizing the customer probability data and inventory probability data to generate selection data.

### BACKGROUND

Retail environments are ever challenging. Consumers are increasingly pressed for time and are additionally confronted with information about a continuously increasing number of products. Traditionally, consumers encounter a number of obstacles when attempted to quickly enter a store, select a product, and leave including determining a selection of a product (sorting between competitors, brands, pricings, sales, etc.), checking out, and providing payment for the selected products. However, consumers are increasingly favoring options that reduce the amount of obstacles between the start and end of the shopping experience. Thus, a growing number of consumers are turning to online shopping for day-to-day purchases. Furthermore, a retailer's overall performance and profits are significantly impacted by the challenge of reducing the amount of obstacles between a customer entering the store, and leaving with the product(s) they wish to buy. Therefore, a desire exists for solutions that help retailers increase operational efficiencies, create intimate customer experiences, streamline processes, and provide real-time understanding of customer behavior in the store. Provided herein are frictionless shopping systems and methods that address the foregoing.

In addition, customers often enter a retail location or pass by a retail exhibit (e.g., vending machine or small retail stand such as in a mall, an airport, a hospital, etc.) and fail to notice objects on some shelving units or fail to realize promotions or discounts apply to certain objects. When shopping at a retail location, customers are often distracted for a variety of reasons including looking at their mobile device, talking on their mobile device and/or watching children. Thus, it would be advantageous for retail locations and manufacturers that have inventory for sale at retail locations to be able to: (i) cause customers to notice a particular shelving unit, and (ii) provide entertaining and attractive graphics that grab customers' attention and also provide promotion as well as product information.

Finally, retailers are constantly concerned with the stocking of their shelves. A retailer may lose money due to a failure to restock inventory. For example, a customer may approach a shelf seeking to purchase a particular item; however, the shelf indicated as the location of the particular item may be empty. In some situations, a retailer may have that particular item stored in the back of the store but due to a lack of knowledge that the shelf was empty, the shelf was not restocked with the item causing the retailer to lose the money the customer would have spent on purchasing the particular item. Such a situation occurs at a high rate and may cost a retailer thousands or even millions of dollars in lost revenue each year.

### BRIEF DESCRIPTION OF THE DRAWINGS

The invention may best be understood by referring to the following description and accompanying drawings that are used to illustrate embodiments of the invention. In the drawings:

FIG. 1 provides an illustration of an frictionless shopping system network in accordance with some embodiments;

FIG. 2 provides an illustration of a frictionless shopping system within a store of FIG. 1 in accordance with some embodiments;

FIG. 3 provides an illustration of an intelligent shelf system in accordance with some embodiments;

FIG. 4 provides a hardware block diagram of a frictionless shopping system coupled with an intelligent shelf in accordance with some embodiments;

FIG. 5 provides a first logical representation of the frictionless shopping system in accordance with some embodiments;

FIG. 6 provides a second logical representation of the frictionless shopping system in accordance with some embodiments;

FIG. 7 provides a third logical representation of the frictionless shopping system in accordance with some embodiments;

FIG. 8A provides an illustration of a three-dimensional shopping area space generated by the frictionless shopping system in accordance with some embodiments;

FIG. 8B provides an illustration of an overhead two-dimensional shopping area space generated by the frictionless shopping system in accordance with some embodiments;

FIG. 8C provides an illustration of a series of images captured by a plurality of customer recognition cameras of the frictionless shopping system in accordance with some embodiments;

FIG. 9A provides an illustration of an image being processed with skeletal recognition techniques captured by a customer recognition camera of the frictionless shopping system in accordance with some embodiments;

FIG. 9B provides an illustration of multiple images being processed with customer recognition techniques captured by a customer recognition camera of the frictionless shopping system in accordance with some embodiments;

FIG. 10A provides an illustration of an image being processed with inventory recognition techniques captured by an inventory camera of the frictionless shopping system in accordance with some embodiments; and

FIG. 10B provides an illustration of multiple images being processed with inventory recognition techniques captured by an inventory camera of the frictionless shopping system in accordance with some embodiments.

### DETAILED DESCRIPTION

Before some particular embodiments are provided in greater detail, it should be understood that the particular embodiments provided herein do not limit the scope of the concepts provided herein. It should also be understood that a particular embodiment provided herein can have features that may be readily separated from the particular embodiment and optionally combined with or substituted for features of any of a number of other embodiments provided herein.

Regarding terms used herein, it should also be understood the terms are for the purpose of describing some particular embodiments, and the terms do not limit the scope of the concepts provided herein. Ordinal numbers (e.g., first, second, third, etc.) are generally used to distinguish or identify different features or steps in a group of features or steps, and do not supply a serial or numerical limitation. For example, “first,” “second,” and “third” features or steps need not necessarily appear in that order, and the particular embodiments including such features or steps need not necessarily be limited to the three features or steps. Labels such as “left,” “right,” “front,” “back,” “top,” “bottom,” “forward,” “reverse,” “clockwise,” “counter clockwise,” “up,” “down,” or other similar terms such as “upper,” “lower,” “aft,” “fore,” “vertical,” “horizontal,” “proximal,” “distal,” and the like are used for convenience and are not intended to imply, for example, any particular fixed location, orientation, or direction. Instead, such labels are used to reflect, for example, relative location, orientation, or directions. Singular forms of “a,” “an,” and “the” include plural references unless the context clearly dictates otherwise. Unless defined otherwise, all technical and scientific terms used herein have the same meaning as commonly understood by those of ordinary skill in the art.

In general, the present disclosure describes systems, methods, and apparatuses for frictionless shopping that provides shopping experiences with reduced obstacles for consumers between entering and leaving a store. This can be accomplished by providing a means of intelligently tracking inventory on, for example, intelligent retail shelves with capabilities that provide a means of determining the proximity of retail customers as they approach, and collect data related to the inventory and customers including their location, actions, identity, and overall engagement with the shopping experience.

In one embodiment, the frictionless shopping system is comprised of at least one intelligent shelving system, with a cabinet top display, fascia, a proximity sensor, one or more inventory sensors, and one or more demographic tracking sensors. The cabinet top display is configured to display animated and/or graphical content and is mounted on top of in-store shelves. The fascia includes one or more panels of light-emitting diodes (LEDs) configured to display animated and/or graphical content and to mount to an in-store retail shelf. The frictionless shopping system also includes a product presentation system that includes a media player configured to simultaneously execute a multiplicity of media files that are displayed on the cabinet top and the fascia. The cabinet top and the fascia are configured to display content so as to entice potential customers to approach the shelves, and then the fascia may switch to displaying pricing and other information pertaining to the merchandise on the shelves once a potential customer approaches the shelves. The proximity sensor is configured to detect the presence of potential customers. Further, one or more inventory sensors may be configured to track the inventory stocked on one or more in-store retail shelves. Also, one or more customer recognition cameras may be configured to identify and track customers within a given shopping area. The frictionless shopping system may also create one or more alerts once the stocked inventory remaining on the shelves is reduced to a predetermined minimum threshold quantity. All of these methods and features may be networked and expanded over additional intelligent shelving units and the processing of all of the data may be either centralized or distributed across the processor(s) residing within the plurality of intelligent shelves and/or frictionless shopping devices.

Additionally, all of the captured inventory and customer data is processed and analyzed to determine customer actions within the shopping area including whether a customer has selected a product from the shelf, determining what product was selected, adjusting inventory levels accordingly, and extract payment for the selected product based on a pre-determined rule that indicates a purchase has been made by the customer. In certain embodiments, the purchase information is received and/or coordinated by a companion application running on a customer's personal computing device. This can allow for customer's to provide feedback as to what items are being purchased, and provide payment information and authorization. In additional embodiments, the frictionless shopping system can provide the customer with a portable computing device that is specifically designed to aid in the tracking of the customer within the store and provides a means of inputting payment information and authorization. In further embodiments, a customer signs up for an account with the store including their personal data, payment information, and payment authorization. This can provide a method for a customer to enter a store, select items off of a shelf, and leave without interacting with a store employee or application on the personal computing device or the customer's mobile computing device. The frictionless shopping system in these instances can track the customer entering the store, gather data regarding the customer, identify the customer based on data stored in the customer's account with the store, determine what products were selected off of the shelf, and initiating a sale utilizing the customer payment info and authorization associated with their account upon initiation of a pre-determined action by the customer indicating a sale should be processed (e.g. entering a checkout area of the store with the products, or leaving the store with the products, etc.).

In this way, frictionless shopping systems allow for stores and other retailers to provide a means of selling products to consumers that compete with methods of shopping that shoppers find in an online environment. Furthermore, the frictionless shopping system allows for reduced manpower needed to check out customers purchasing items, provides a way for inventory to be tracked at near-real time with up to per-item resolution, and/or creates engaging shopping experiences that can better engage consumers that may otherwise not become aware of a given product or promotion.

I. System Architecture

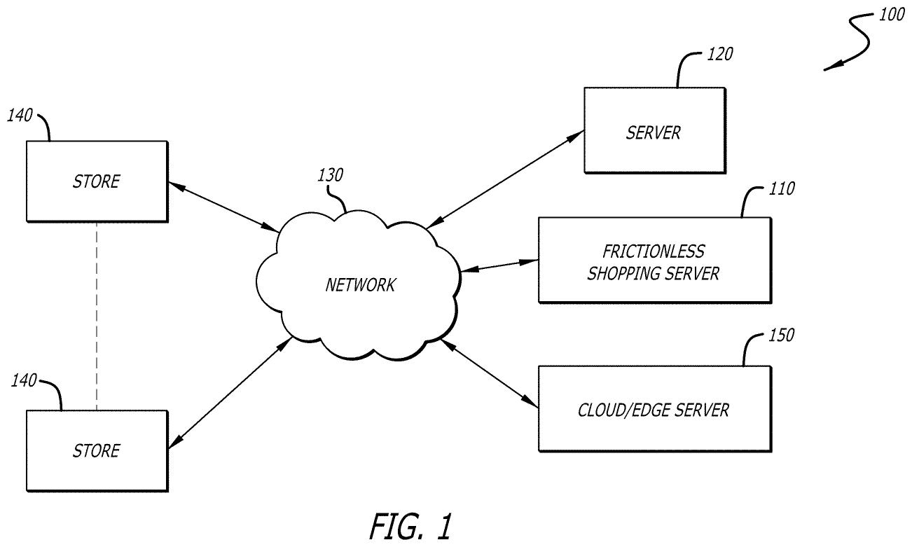

Referring now to FIG. 1, an illustration of an frictionless shopping system network 100 in accordance with some embodiments is shown. The frictionless shopping system can exist within a larger frictionless shopping system network 100. In some embodiments, the frictionless shopping system may be entirely contained within a store 140. In certain embodiments, the frictionless shopping system may be installed in multiple stores 140 and can have its operations be supplemented by facilitating a communication link between the multiple stores 140.

In further embodiments, the frictionless shopping system may utilize a network 130 such as the Internet to facilitate a remote connection to other devices that may supplement and/or aid the function of the frictionless shopping system. In certain embodiments, the frictionless shopping system may utilize a general purpose server 120 to provide data processing, storage, and/or retrieval required for the frictionless shopping system. In these embodiments, the server 120 may be utilized for a variety of purposes including, but not limited to, updating data within a store-located frictionless shopping system, providing updated inventory data, providing updated pricing data, providing new and updated customer data, and/or receiving new promotional data. It should be known to those skilled in the art that the server 120 may be utilized by the frictionless shopping system to update or supplement any type of data utilized.

In additional embodiments, stores 140 may comprise one or more intelligent shelves but not any frictionless shopping systems. In these embodiments, a frictionless shopping server 110 may be utilized to add such functionality to a pre-existing system and/or installation. By way of example and not limitation, the frictionless shopping server 110 may receive data from the intelligent shelves including, but not limited to, image data captured from the sensors/cameras on the intelligent shelves within the store 140 and transmit the data over the network 130 to the frictionless shopping server 110 for processing and inventory, customer, and probability data generation which may then be either further processed by the frictionless shopping server 110 or can be transmitted back to the store 140 for further processing. In this way, the frictionless shopping system may be marketed as a service that may be added on to stores 140 with existing hardware that can facilitate the frictionless shopping system.

In more embodiments, portions of the frictionless shopping system may be served by the use of a cloud/edge server 150 from a third party. As those skilled in the art can recognize, the use of cloud/edge servers 150 can allow for both increased data delivery and transmission speeds, as well as ease of scalability should the frictionless shopping system be implemented quickly over a large area or number of stores 140. In these embodiments, the cloud/edge server can facilitate many aspects of the frictionless shopping system up to providing the entire frictionless shopping processing necessary for implementation. By way of example and not limitation, the cloud/edge server 150 may in some embodiments house all of the data stores necessary for the frictionless shopping system. In additional embodiments, the cloud/edge server 150 may provide or supplement image processing capabilities or provide ground truth data with a variety of machine learning, predetermined rule sets, and/or deep convolutional neural networks.

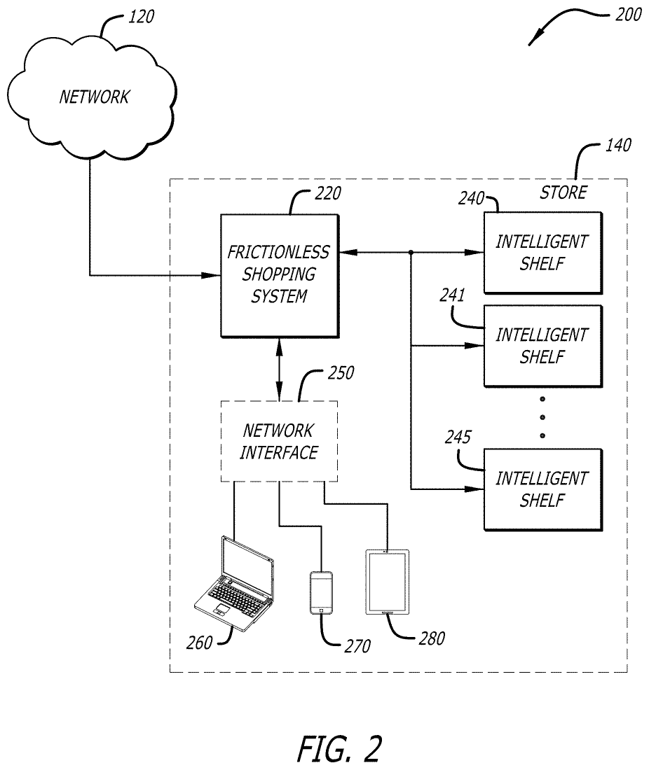

Referring now to FIG. 2, an illustration of a frictionless shopping system within a store of FIG. 1 in accordance with some embodiments is shown. As discussed above, a frictionless shopping system 220 can be deployed within a store 140 to create a frictionless shopping experience. The frictionless shopping system 220 is typically connected to an external network 120 that may provide a variety of data including, but not limited to, inventory updates, customer data updates, system updates, ground truth data, and/or promotional data updates. Similarly, the frictionless shopping system 220 may utilize the network 120 to transmit data to an external server or cloud/edge server as depicted in FIG. 1. In certain embodiments the data externally communicated can include, but is not limited to, inventory data, customer data, engagement data, proximity data, and/or data related to image processing.

In many embodiments, the frictionless shopping system is commutatively connected to a plurality of intelligent shelves 240, 241, 245. It should be understood that while only three intelligent shelves are depicted in FIG. 2, a store 140 may employ any number of intelligent shelves as is desired/necessary for the given application. In certain embodiments, the frictionless shopping system 220 can be housed within one or more intelligent shelf units. In other embodiments, the frictionless shopping system 220 may be realized by networking multiple intelligent shelves 140, 141, 145 together with the representative components to create a single frictionless shopping system 220.

Optionally, a number of embodiments may include a network interface 250 which may allow the frictionless shopping system 220 to communicate with personal computing devices such as, but not limited to, portable computers 260, smart phones 270, and portable computing tablets 280. In various embodiments, the frictionless shopping system 220 may be configured to push out notifications and/or queries to the mobile computer devices 260, 270, 280 to supplement the frictionless shopping experience. Such notifications and/or queries may include, but are not limited to, sale notifications, selection confirmation queries, payment confirmation queries, and/or device identification information requests. Conversely, connection between the frictionless shopping system 220 and the mobile computing devices 260, 270, 280 via the network interface 250 can also facilitate the receiving of data from the mobile computer devices 260, 270, 280 into the frictionless shopping system. By way of example and not limitation, a customer may have a smart phone with a store loyalty application which can be configured to notify the frictionless shopping system of the presence of the customer within the store. In additional embodiments, the mobile computing devices 260, 270, 280 may also transmit data related to customer location within the store, data related to desired items for purchase (e.g. shopping list data), data related to shopping history (for promotional data selection and display based on such history), and/or payment related data. It is contemplated that all data tracking, sharing, and gathering processes can be facilitated in a manner that is compliant with all local, state, federal, and/or international laws/regulations.

II. Intelligent Shelves

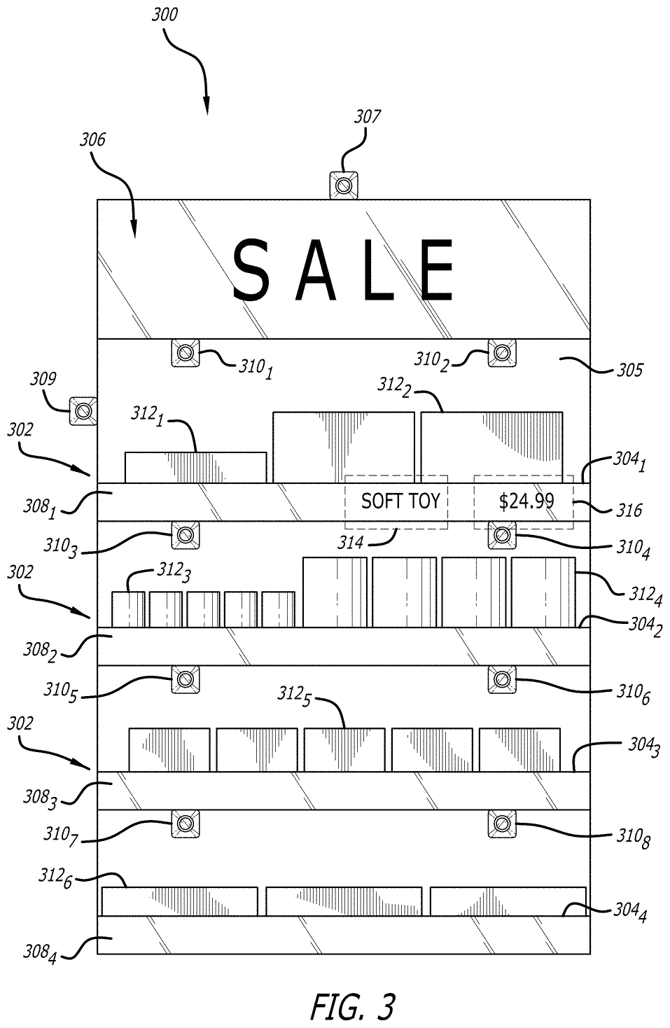

Referring to FIG. 3, an illustration of an intelligent shelf 300 in accordance with some embodiments is shown. The intelligent shelf 300 comprises a proximity sensor 307, fascia 308₁-308₄, a plurality of inventory cameras 310₁-310₁ (wherein i≥1, herein, i=8) and a customer recognition camera 309. It is noted that the disclosure is not limited to the intelligent shelf 300 including a single cabinet display top 306 but may include a plurality of cabinet top displays 306. Additionally, the intelligent shelf 300 is not limited to the number of fascia, shelving units, proximity sensors, customer recognition cameras and/or inventory cameras shown in FIG. 3. In typical embodiments, the intelligent shelf 300 couples to a shelving unit 302, which includes shelves 304, a back component 305 (e.g., pegboard, gridwall, slatwall, etc.) and a cabinet top display 306.

In one embodiment, the cabinet display top 306 is coupled to an upper portion of the shelving unit 302, extending vertically from the back component 305. Further, a proximity sensor 307 may be positioned on top of, or otherwise affixed to, the cabinet top display 306. Although the proximity sensor 307 is shown in FIG. 3 as being centrally positioned atop the cabinet top display 306, the proximity sensor 307 may be positioned in different locations, such as near either end of the top of the cabinet top 306, on a side of the cabinet top 306 and/or at other locations coupled to the shelving unit 302 and/or the fascia 308. It is contemplated that any of the sensors and/or cameras may employ depth tracking technology to create depth maps that can be utilized by any of the logics presented within the frictionless shopping system.

The cabinet display top 306 and fascia 308 may be attached to the shelves 304 by way of any fastening means deemed suitable, wherein examples include, but are not limited or restricted to, magnets, adhesives, brackets, hardware fasteners, and the like. The fascia 308 and the cabinet display top 306 may each be comprised of one or more arrays of light emitting diodes (LEDs) that are configured to display visual content (e.g., still or animated content), with optional speakers, not shown, coupled thereto to provide audio content. Any of the fascia 308 and/or the cabinet display top 306 may be comprised of relatively smaller LED arrays that may be coupled together so as to tessellate the cabinet display top 306 and the fascia 308, such that the fascia and cabinet top desirably extend along the length of the shelves 304. The smaller LED arrays may be comprised of any number of LED pixels, which may be organized into any arrangement to conveniently extend the cabinet display top 306 and the fascia 308 along the length of a plurality of shelves 304. In some embodiments, for example, a first dimension of the smaller LED arrays may be comprised of about 332 or more pixels. In some embodiments, a second dimension of the smaller LED arrays may be comprised of about 62 or more pixels.

The cabinet display top 306 and the fascia 308 may be configured to display visual content to attract the attention of potential customers. As shown in FIG. 3, the cabinet display top 306 may display desired visual content that extends along the length of the shelves 304. The desired content may be comprised of a single animated or graphical image that fills the entirety of the cabinet display top 306, or the desired content may be a group of smaller, multiple animated or graphical images that cover the area of the cabinet display top 306. In some embodiments, the fascia 308 may cooperate with the cabinet display top 306 to display either a single image or multiple images that appear to be spread across the height and/or length of the shelves 304.

In some embodiments, the cabinet display top 306 may display visual content selected to attract the attention of potential customers to one or more products comprising inventory 312, e.g., merchandise, located on the shelves 304. Thus, the visual content shown on the cabinet display top 306 may be specifically configured to draw the potential customers to approach the shelves 304, and is often related to the specific inventory 312 located on the corresponding shelves 304. A similar configuration with respect to visual content displayed on the fascia 308 may apply as well, as will be discussed below. The content shown on the cabinet display top 306, as well as the fascia 308, may be dynamically changed to engage and inform customers of ongoing sales, promotions, and advertising. As will be appreciated, these features offer brands and retailers a way to increase sales locally by offering customers a personalized campaign that may be easily changed quickly.

Moreover, as referenced above, portions of the fascia 308 may display visual content such as images of brand names and/or symbols representing products stocked on the shelves 304 nearest to each portion of the fascia. For example, in an embodiment, a single fascia 308 may be comprised of a first portion 314 and a second portion 314. The first portion 314 may display an image of a brand name of inventory 312 that is stocked on the shelf above the first portion 314 (e.g., in one embodiment, stocked directly above the first portion 314), while the second portion 316 may display pricing information for the inventory 312. Additional portions may include an image of a second brand name and/or varied pricing information when such portions correspond to inventory different than inventory 312. It is contemplated, therefore, that the fascia 308 extending along each of the shelves 304 may be sectionalized to display images corresponding to each of the products stocked on the shelves 304. It is further contemplated that the displayed images will advantageously simplify customers quickly locating desired products.

In an embodiment, the animated and/or graphical images displayed on the cabinet display top 306 and the fascia 308 are comprised of media files that are executed by way of a suitable media player. The media player preferably is configured to simultaneously play any desired number of media files that may be displayed on the smaller LED arrays. In some embodiments, each of the smaller LED arrays may display one media file being executed by the multiplayer, such that a group of adjacent smaller LED arrays combine to display the desired images to the customer. Still, in some embodiments, base video may be stretched to fit any of various sizes of the smaller LED arrays, and/or the cabinet display top 306 and fascia 308. It should be appreciated, therefore, that the multiplayer disclosed herein enables implementing a single media player per aisle in-store instead relying on multiple media players dedicated to each aisle.

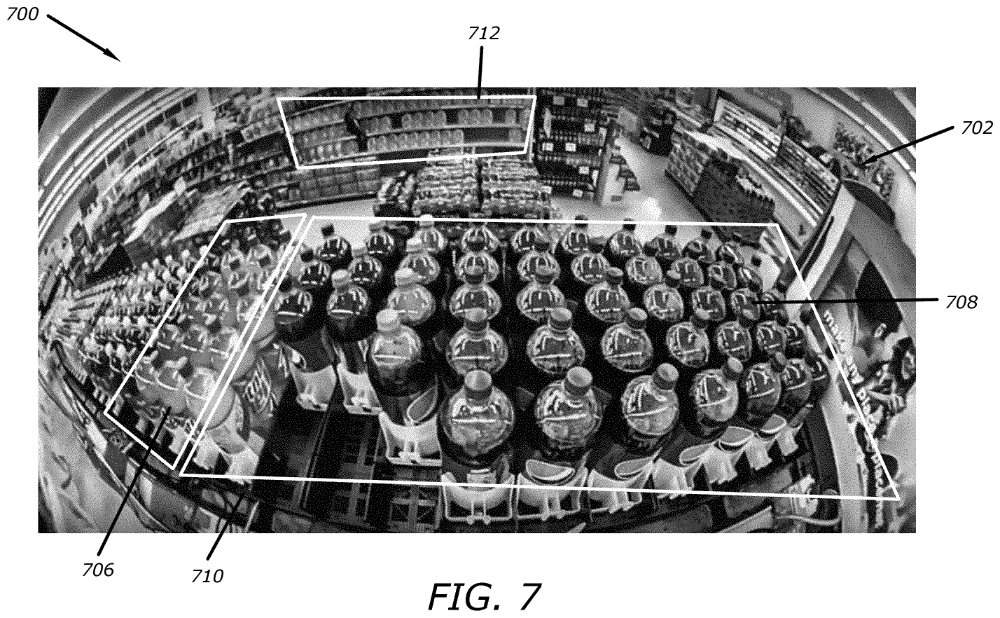

Furthermore, FIG. 3 illustrates a plurality of inventory cameras 310 (i.e., the inventory cameras 310₁-310₈). In some embodiments, the inventory cameras 310 are coupled to the shelving unit 302, e.g., via the pegboard 305, and positioned above merchandise 312, also referred to herein as “inventory.” Each of the inventory cameras 310 is configured to monitor a portion of the inventory stocked on each shelf 304, and in some instances, may be positioned below a shelf 304, e.g., as is seen with the inventory cameras 310₃-310₈. However, in some instances, an inventory camera 310 may not be positioned below a shelf 304, e.g., as is seen with the inventory cameras 310₁-310₂. Taking the inventory camera 310₄, as an example, the inventory camera 310₄ is positioned above the inventory portion 316 and therefore capable of (and configured to), monitor the inventory portion 316. Although, it should be noted that the inventory camera 310₄ may have a viewing angle of 180° (degrees) and is capable of monitoring a larger portion of the inventory 312 on the shelf 304₂ than merely inventory portion 316. For example, FIG. 7 illustrates one exemplary image captured by an inventory camera having a viewing of 180°.

It will be known to those skilled in the art that the positioning of the inventory cameras 310 may differ from the illustration of FIG. 3. In addition to being positioned differently with respect to spacing above inventory 312 on a particular shelf 304, the inventory cameras 310 degree may be affixed to the shelving unit 302 in a variety of manners, which such being upon the type of shelves 304 as well as the type of inventory 312.

In addition to the proximity sensor 307 and the inventory cameras 310₁-310₈, the intelligent shelf 300 is seen to include a customer recognition camera 309. In one embodiment, the customer recognition camera 309 may be coupled to the exterior of the shelving unit 302. In some embodiments, the customer recognition camera 309 may positioned five to six feet from the ground in order to obtain a clear image of the faces of a majority of customers. In further embodiments, the intelligent shelf 300 may comprise multiple customer recognition cameras that can be placed in a variety of locations to better capture customer recognition data such as, but not limited to, spatial location and/or facial data. The customer recognition camera 309 may be positioned at heights other than five to six feet from the ground. The customer recognition camera 309 need not be coupled to the exterior of the shelving unit 302 as illustrated in FIG. 3; instead, the illustration of FIG. 3 is merely one embodiment. The customer recognition camera 309 may be coupled to in the interior of a side of the shelving unit 309 as well as to any portion of any of the shelves 304₁-304₄, the cabinet display top 306, the fascia 308 and/or the back component 305 of the shelving unit 302. Further, a plurality of customer recognition cameras 309 may be coupled to the shelving unit 302.

In some embodiments, the intelligent shelf 300 may include one or more processors, a non-transitory computer-readable memory, one or more communication interfaces, and logic stored on the non-transitory computer-readable memory. The images or other data captured by the proximity sensor 307, the customer recognition camera 309 and/or the inventory cameras 310₁-310₈ may be analyzed by the logic of the intelligent shelf 300. The non-transitory computer-readable medium may be local storage, e.g., located at the store in which the proximity sensor 307, the customer recognition camera 309 and/or the inventory cameras 310₁-310₈ reside, or may be cloud-computing storage. Similarly, the one or more processors may be local to the proximity sensor 307, the customer recognition camera 309 and/or the inventory cameras 310₁-310₈ or may be provided by cloud computing services.

Examples of the environment in which the intelligent shelf 300 may be located include, but are not limited or restricted to, a retailer, a warehouse, an airport, a high school, college or university, any cafeteria, a hospital lobby, a hotel lobby, a train station, or any other area in which a shelving unit for storing inventory may be located.

III. Frictionless Shopping Systems

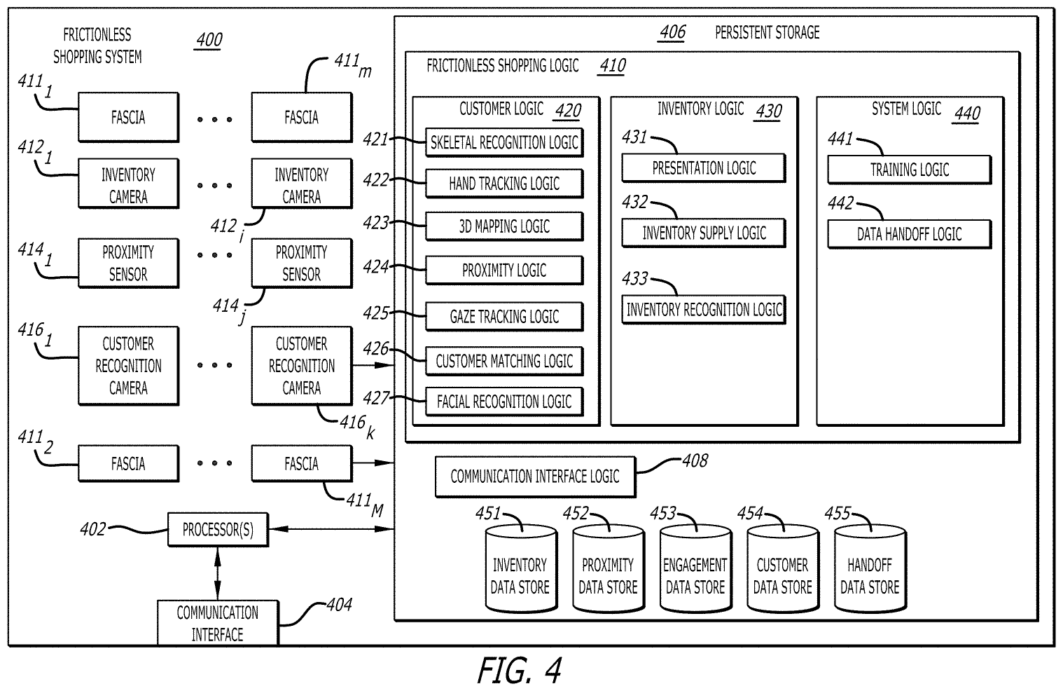

Referring to FIG. 4, a first logical representation of the frictionless shopping system in accordance with some embodiments is shown. In one embodiment, frictionless shopping system 400, may include one or more processors 402 that are coupled to a communication interface 404. The communication interface 404, in combination with a communication interface logic 408, enables communications with external network devices and/or other network appliances to transmit and receive data. According to one embodiment of the disclosure, the communication interface 404 may be implemented as a physical interface including one or more ports for wired connectors. Additionally, or in the alternative, the communication interface 404 may be implemented with one or more radio units for supporting wireless communications with other electronic devices. The communication interface logic 408 may include logic for performing operations of receiving and transmitting data via the communication interface 404 to enable communication between the frictionless shopping system 400 and network devices via a network (e.g., the internet) and/or cloud computing services, not shown.

The processor(s) 402 is further coupled to a persistent storage 406. According to one embodiment of the disclosure, the persistent storage 406 may store logic as software modules including a frictionless shopping system logic 410 and the communication interface logic 408. The operations of these software modules, upon execution by the processor(s) 402, are described below. Of course, it is contemplated that some or all of this logic may be implemented as hardware, and if so, such logic could be implemented separately from each other.

Additionally, the frictionless shopping system 400 may be integrated within an intelligent shelf and include hardware components such as fascia 411₁-411ₘ (wherein m≥1), inventory cameras 412₁-412ᵢ (wherein i≥1), proximity cameras 414₁-414ⱼ (wherein j≥1), and customer recognition cameras 416₁-416ₖ (wherein k≥1). For the purpose of clarity, couplings, i.e., communication paths, are not illustrated between the processor(s) 402 and the fascia 411₁-411ₘ, the inventory cameras 412₁-412ᵢ, the proximity cameras 414₁-414ⱼ, and the customer recognition cameras 416₁-416ₖ; however such couplings may be direct or indirect and configured to allow for the provision of instructions from the frictionless shopping system logic 410 to such components.

Each of the inventory cameras 412₁-412ᵢ, the proximity sensors 414₁-414ⱼ, and the customer recognition cameras 416₁-416ₖ may be configured to capture images, e.g., at predetermined time intervals or upon a triggering event, and transmit the images to the persistent storage 406. The frictionless shopping system logic 410 may, upon execution by the processor(s) 402, perform operations to analyze the images. Specifically, the frictionless shopping system logic 410 includes customer logic 420, inventory logic 430, and system logic 440. Each of these logics comprise further sub logics, which will be discussed in more detail below. Generally, the frictionless shopping logic 410 is configured to, upon execution by the processor(s) 402, perform operations to receiving an image from a sensor, such as the inventory cameras 412₁-412ᵢ and/or customer recognition cameras 416₁-416ₖ. In some embodiments, the frictionless shopping logic 410 may receive a trigger, such as a request for a determination as to whether an inventory set needs to be restocked or if a new customer is detected to be within the shopping area, and request an image be captured by one or more of the inventory cameras 412₁-412ᵢ and/or customer recognition cameras 416₁-416ₖ. In a number of embodiments, images captured by the inventory cameras 412₁-412ᵢ are processed by the inventory logic 430, while images acquired from the customer recognition cameras 416₁-416ₖ and/or proximity sensors 414₁-414ⱼ are processed by the customer logic 420.

The inventory logic 430 may comprise an inventory recognition logic 433. The inventory recognition logic 433 is configured to, upon execution by the processor(s) 402, perform operations to analyze an image received by an inventory camera 412₁-412ᵢ, including object recognition techniques. In some embodiments, the object recognition techniques may include the use of machine learning, predetermined rule sets and/or deep convolutional neural networks. The inventory recognition logic 433 may be configured to identify one or more inventory sets within an image and determine an amount of each product within the inventory set. In addition, the inventory recognition logic 433 may identify a percentage, numerical determination, or other equivalent figure that indicates how much of the inventory set remains on the shelf (i.e., stocked) relative to an initial amount (e.g., based on analysis and comparison with an earlier image and/or retrieval of an initial amount predetermined and stored in a data store, such as the inventory threshold data store 430).

The inventory supply logic 432 is configured to, upon execution by the processor(s) 402, perform a variety of operations including retrieving one or more predetermined thresholds and determine whether the inventory set needs to be restocked. A plurality of predetermined thresholds, which may be stored in the inventory supply logic 432, may be utilized in a single embodiment. For example, a first threshold may be used to determine whether the inventory set needs to be stocked and an alert transmitted to, for example, a retail employee (e.g., at least a first amount of the initial inventory set has been removed). In addition, a second threshold may be used to determine whether a product delivery person needs to deliver more of the corresponding product to the retailer (e.g., indicating at least a second amount of the initial inventory set has been removed, the second amount greater than the first amount). In such an embodiment, when the second threshold is met, alerts may be transmitted to both a retail employee and a product delivery person.

In further embodiments, the inventory supply logic 432 and inventory recognition logic 433 can be utilized to further the frictionless shopping experience by generating data related to what type of inventory is being selected by shoppers. In such embodiments, the inventory recognition logic 433 may further process images that can generate data to determine what product is being held by a customer, and/or to determine what specific inventory product was grabbed by the customer off of the shelf for purchase. In certain embodiments, the image processing accomplished by the inventory recognition logic 433 may be supplemented by the data generated by the inventory supply logic 432 which may include data related to the location and/or stock quantities related to the products recognized by the image processing. By way of example and not limitation, the inventory recognition logic 433 may be attempting to determine which product was selected by a customer off of the shelf and has two strong candidates generated. In this case, the selection of which candidate is chosen may be supplemented by accessing inventory supply logic 432 by, for example, recognizing that a first candidate is showing zero stock in the store while the second candidate has multiple items in stock, leading the inventory recognition logic 433 to select the second candidate because it is more likely to be the correct selection based on the known inventory stock data.

It is contemplated that the inventory logic 430 may also be supplemented by the customer logic 420 for various processes. By way of example and not limitation, the inventory recognition logic 433 may again be attempting to determine which product was selected by a customer off of the shelf and has two strong candidates generated based on the image processing. In this case, the selection of which candidate is chosen may be supplemented by accessing customer logic 420 by, for example, recognizing that a first candidate is a product that is routinely purchased by the customer while the second candidate is not typically purchased by the customer, leading the inventory recognition logic 433 to select the first candidate because it is more likely to be the correct selection based on the known customer data.

In additional embodiments, all data related to inventory utilized by the inventory logic 430 may be stored in an inventory data store 451. As those skilled in the art will recognize, the inventory data store 451 may be located within the same persistent storage 406 as the inventory logic 430 as is shown in FIG. 4, but it may also be stored on a separate physical memory storage device that may be located either within the frictionless shopping system 400 or within another device and/or remotely in a cloud-based server.

Inventory logic 430 may also include presentation logic 431 which can store presentation data related to the graphics presented on intelligent shelves. In certain cases, the presentation logic 431 may work in tandem with the proximity logic 424 to generate specific graphics on the intelligent shelf fascia within a first proximity and then to present alternative graphics when the customer is engaged and comes within a closer proximity of the intelligent shelf. In further embodiments, the proximity logic 424 may work in tandem with both the proximity logic 424, but also customer matching logic 426 that can be utilized to present specific graphics on intelligent shelves based upon both the proximity data provided by the proximity logic 424 as well as customer-related data from the customer matching logic 426. In this way, the frictionless shopping system 400 can utilize these data sets to match a customer to their customer data, determine when that specific customer is within a given pre-determined distance, and then select and present graphics on at least one intelligent shelf based upon preferences and/or shopping history of that particular customer. Further, embodiments of presentation logic 431 can include processes for displaying price tags and pricing information upon the customer entering within a pre-determined proximity of the intelligent shelf. In many embodiments, the presentation logic 431 can store data related to promotional campaigns and/or customer engagement in the engagement data store 453. It is contemplated that the engagement data store 453 can store data related to various aspects of tracking customer engagement with the various promotions for the purpose of creating metrics or other data that may be utilized by stores or inventory manufacturer's to increase sales or provide insight into customer shopping trends and/or practices.

The customer logic 420 is configured to, upon execution by the processor(s) 402, perform operations related to data associated with the customer. In some embodiments, the customer logic may comprise several sub-logics with their own functions. In the embodiment depicted in FIG. 4, the customer logic 420 comprises skeletal recognition logic 421, hand tracking logic 422, three-dimensional mapping logic 423 (shown as “3D mapping logic”), proximity logic 424, gaze tracking logic 425, customer matching logic 426, and facial recognition logic 427.

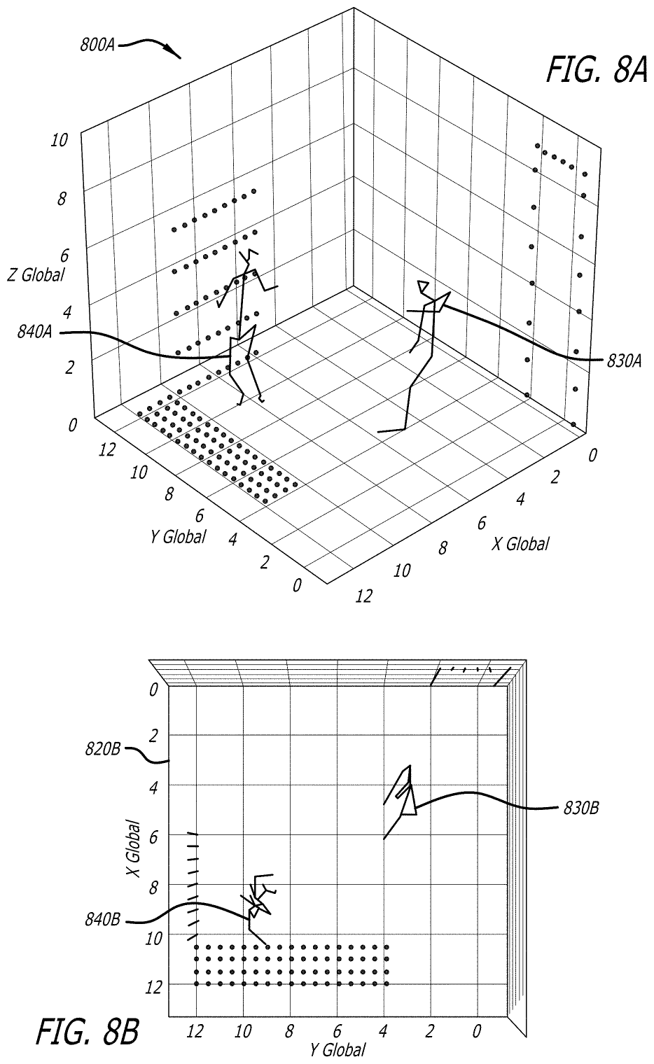

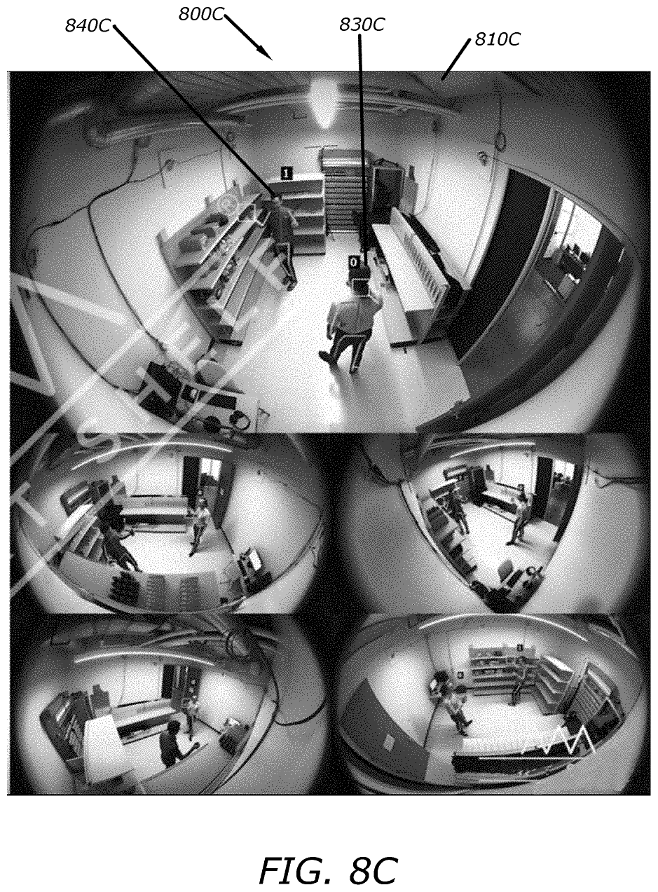

In a number of embodiments, the customer logic 420 can include a skeletal recognition logic 421. Skeletal recognition can be done through the processing of image data generated by any of the sensors/cameras on the intelligent shelving units. In certain embodiments, the captured image data is supplemented by depth map data. As shown in more detail below in the discussion of FIGS. 8A-8C, the frictionless shopping system 400 may acquire image data of a given shopping area and attempt to extract the location of a variety of limbs, joints, head, and/or torso locations of customers within the image. In many embodiments, the generation of such data may aid the frictionless shopping system 400 to determine how many customers are within the shopping area, what direction they are facing, and where they are in relation to the one or more intelligent shelves. In certain embodiments, this skeletal recognition data may be utilized by other logics for supplemental processing including, for example, the gaze tracking logic 425 which may be aided in a determination of the direction of a customer's gaze based on the determined location of the customer within the shopping area. Furthermore, the three-dimensional mapping logic 423 can be aided in generating a three-dimensional model of the shopping area by utilizing the skeletal recognition data in relation to the images that are being processed.

The skeletal recognition logic 421 can utilize a number of tools to aid in the generation of skeletal recognition data including, but not limited to, image recognition on a plurality of two-dimensional images, machine-learning algorithms applied to images with corresponding depth map data (RGB-D), and/or statistical modeling to generate improved results (e.g. Markov models.) It is contemplated that any variety of machine learning, predetermined rule sets, and/or deep convolutional neural networks may be utilized to successfully generate truthful skeletal representations of customers within the shopping area. It is further contemplated that training of the skeletal recognition logic 421 may be done via multiple methods including establishing ground truth data within a controlled lab, incorporating a third-party set of data, and/or training the skeletal recognition logic 421 in the store with real-world experiences. In certain embodiments, the skeletal recognition logic 421 may be aided in its determination and generation of skeletal recognition data by a communication link received from the mobile computer device of the customer within the store (e.g. a smart phone sending compass/directional information to the frictionless shopping system 400.)

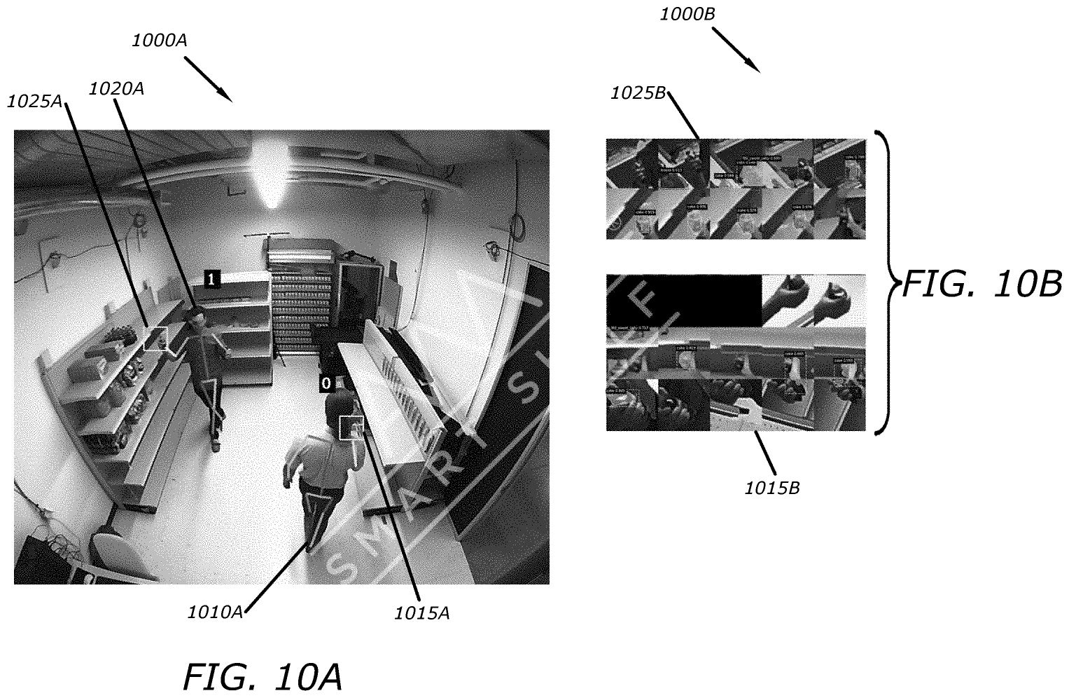

The frictionless shopping system 400 may also comprise hand tracking logic 422 that can be utilized to track the hand of customers within the shopping area. In various embodiments, the hand tracking logic 422 can track the hands of customers to verify that they are holding a product as depicted in FIG. 10B. Hand tracking techniques can be accomplished through a variety of technologies including, but not limited to, computer vision algorithms, neural network processing, and/or inverse kinematics principles. In certain embodiments, the hand tracking logic 422 may be configured to accept a third-party application program interface (“API”) or software development kit (“SDK”) to aid in the generation of hand tracking data. In many embodiments, a goal of the hand tracking logic 422 is to generate hand tracking data that represents the location, orientation, and extension of customer's hands within the three-dimensional shopping space within a given shopping area. This can typically be accomplished by attempting to infer various location points across the hand relating to features such as joints, digits, wrists, and palms.

Similar to the skeletal recognition logic 421, the hand tracking logic 422 may utilize a number of tools to aid in the generation of skeletal recognition data including, but not limited to, image recognition on a plurality of two-dimensional images generated from a plurality of cameras, machine-learning algorithms applied to images with corresponding depth map data (RGB-D), and/or statistical modeling to generate improved results.

It is also contemplated that any variety of machine learning, predetermined rule sets, and/or deep convolutional neural networks may be utilized to successfully generate truthful hand representations of customers within the shopping area. It is further contemplated that training of the hand tracking logic 422 may be done via multiple methods including establishing ground truth data within a controlled lab, incorporating a third-party set of data, and/or training the hand tracking logic 421 in a store with real-world experiences and feedback directed by a system administrator.

As those skilled in the art would recognize, the three-dimensional mapping logic 423 can be aided in generating a three-dimensional model of the shopping area by utilizing the hand tracking data in relation to the images that are being processed. Ultimately, the hand tracking data may be beneficial to other logics that determine whether a customer has selected and grabbed an item off of an intelligent shelf for purchase. Additionally, continued tracking of the product beyond when it is grabbed off of the shelf, may yield further data regarding customer engagement if the product is ultimately put back by the customer and/or carries the inventory around and does not put the product in the basket and/or shopping cart. This type of data may yield insight into customer shopping habits as the time required to place an item from inventory from a shopper's hand into a shopping cart/basket may relate to shopping decisions still being made, which could be useful for the generation of shopping metrics for various parties including the frictionless shopping system administrators and the producers of the inventory being selected.

To aid in the understanding of the shopping area, the frictionless shopping system 400 may comprise three-dimensional mapping logic 423. In many embodiments, the generation of a three-dimensional model can aid in the generation of data related to customer selection. An example of a generated three-dimensional model in accordance with one embodiment of the invention is depicted in FIG. 8A. In certain embodiments, data generated from skeletal recognition logic 421, and hand tracking logic 422 can be utilized to aid in the generation of the three-dimensional model data. In certain embodiments, the three-dimensional mapping logic 423 may also be utilized to generate two-dimensional or pseudo-two-dimensional models similar to the model depicted in FIG. 8B. It is contemplated that a variety of machine learning, predetermined rule sets, and/or deep convolutional neural networks may be utilized to successfully generate data relating to an approximate representation of the three-dimensional shopping area with a plurality of models representing customers present within the shopping area. In further embodiments, the three-dimensional mapping logic 423 can also generate models representing inventory and its location within the three-dimensional space.

The proximity logic 424 is configured to, upon execution by the processor(s) 402, perform operations to analyze images or other signals received from the proximity sensors 414₁-414ⱼ. In some embodiments, the proximity logic 428 may determine when a customer is within a particular distance threshold from the shelving unit on which the inventory set is stocked and transmit a communication (e.g., instruction or command) to the change the graphics displayed on the fascia 411₁-411ₘ. In some embodiments, data related to proximity can be stored within a proximity data store 452. Similar to the other data stores, the proximity data store 452 may be located within the same persistent storage 406 as the customer logic 420 as is shown in FIG. 4, but it may also be stored on a separate physical memory storage device that may be located either within the frictionless shopping system 400 or within another device and/or remotely in a cloud-based server.

In a variety of embodiments, the frictionless shopping system can comprise gaze tracking logic 425 that may generate data relating to the location of a customer's visual gaze. It is widely known to those skilled in the art that a shopper's gaze can yield insightful data relating to the customer's decision making process, receptiveness to visual campaigns utilized, and/or reaction to pricing data. It is contemplated that gaze tracking logic 425 can utilize a variety of machine learning, predetermined rule sets, and/or deep convolutional neural networks to generate data relating to gaze tracking.

Gaze tracking data may be generated in a variety of forms including, but not limited to, heat maps, static location data, and/or linear line maps. The methods of gaze tracking typically involve image processing of images captured from a plurality of cameras. In certain embodiments, the images utilized for gaze tracking are captured from a color camera and/or an infrared camera.

In most embodiments, the frictionless shopping system 400 comprises customer matching logic 426. Customer matching logic 426 can be utilized for a variety of operations including, but not limited to, determining trends in customers based on ethnicity, age, gender, time of visit, geographic location of the store, etc. Based on additional analysis, the frictionless shopping system logic 410 may determine trends in accordance with a variety of factors including, but not limited to, graphics displayed by the frictionless shopping system 400, sales, time of day, time of the year, day of the week, etc. Customer matching logic 426 can be utilized to access customer information and/or accounts within a customer data store 454 and match a customer recognized within a store with the customer account. Customer related data generated during frictionless shopping can be added to the customer data store 454 and associated with a specific customer account or anonymized and stored for future analysis.

Customer matching can be accomplished utilizing other customer and inventory logics. Matching may also be accomplished through the utilizing data received from a customer's mobile computing device in communication with the frictionless shopping system 400. By way of example and not limitation, a customer may enter a store with a mobile phone that is loaded with an application that can create a data connection with the frictionless shopping system 400. Upon entering the store, the application may utilize GPS data to determine that the customer is within a store and transmits the data to the frictionless shopping system 400. Based upon this data, the frictionless shopping system 400 may determine that a particular customer determined to be within the shopping area is the customer associated with the application account. Data regarding the customer's age, height, etc. can be utilized to further match a recognized customer with an account associated with the customer.

Upon matching the customer, all relevant data can be associated between the customer detected within the shopping area, and the customer account info that has been derived. In certain embodiments, the relevant data may include demographics data, shopping history/patterns, and payment and/or preauthorization rules that are associated with an authorized method of payment the customer has set up in their account.

The facial recognition logic 427 is configured to, upon execution by the processor(s) 402, perform operations to analyze images from the facial recognition cameras 416₁-416ₖ. In some embodiments, the facial recognition logic 726 may look to determine trends in customers based on ethnicity, age, gender, time of visit, geographic location of the store, etc., and, based on additional analysis, the automated inventory intelligence system logic 410 may determine trends in accordance with graphics displayed by the frictionless shopping system 400, sales, time of day, time of the year, day of the week, etc.

In many embodiments, a set of training logic 441 is a sub-set of the system logic 440. The training logic 441 may be comprised of data necessary for the various image processing algorithms utilized in other logics. It is contemplated that the training data may be provided by a third party vendor or inventory manufacturer. In further embodiments the training logic 441 may be updated and/or trained after the frictionless shopping system 400 installation. The training logic 440 can be provided periodically or aperiodically based on the needs to the application. By way of example and not limitation, updates may be provided from the manufacturer for new products.

In many embodiments, the frictionless shopping system 400 may be coupled with a plurality of intelligent shelving units that may include a plurality of facial recognition cameras 416₁-416ₖ. Each intelligent shelf can cover a pre-determined shopping area. Stores may contain large shopping areas that need multiple intelligent shelves to cover the entire desired shopping area. In these embodiments, data handoff logic 442 may facilitate a transfer of data between the plurality of intelligent shelves. By way of example, and not limitation, a first intelligent shelf may process data related to recognizing customers in a first shopping area, while the customer travels outside of the first shopping area and into a second shopping area covered by a second intelligent shelf. In this instance, the data handoff logic 442 of the first intelligent shelf can facilitate and transfer the data necessary for further processing to the second intelligent shelf memory. It is contemplated that the data handoff logic 442 may further handoff data for processing to remote systems, servers, and/or other cloud services for further processing. In a number of embodiments, the data required to be transmitted or received as part of the hand off process may be stored within a handoff data store 455.

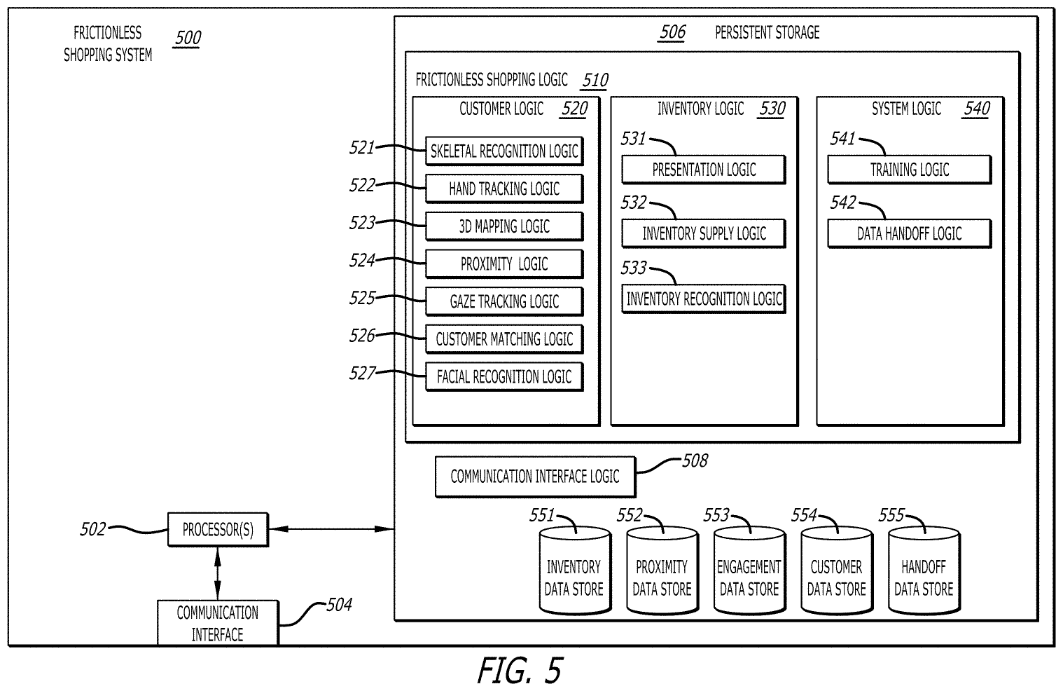

Referring to FIG. 5, a second logical representation of the frictionless shopping system 500 in accordance with some embodiments is shown. The frictionless shopping system 500 depicted is similar to the frictionless shopping system 400 of FIG. 4, however, this depicted embodiment is not directly embedded or attached to an intelligent shelf. In certain embodiments, the frictionless shopping system 500 can be realized as a standalone device that may be physically located away from the intelligent shelving units. In this way, the frictionless shopping system 500 may be added to a pre-existing intelligent shelf system without the need to add new hardware and/or logic to the intelligent shelves. The communication between the frictionless shopping system 500 and the intelligent shelves associated with the shopping areas to be processed with the communication logic 508 of the frictionless shopping system 500.

Similar to the frictionless shopping system 400 depicted in FIG. 4, the frictionless shopping system 500 may comprise one or more processors 502 that are coupled to a communication interface 504. The communication interface 504, in combination with a communication interface logic 508, enables communications with external network devices and/or other network appliances to transmit and receive data. According to one embodiment of the disclosure, the communication interface 504 may be implemented as a physical interface including one or more ports for wired connectors. Additionally, or in the alternative, the communication interface 504 may be implemented with one or more radio units for supporting wireless communications with other electronic devices. The communication interface logic 508 may include logic for performing operations of receiving and transmitting data via the communication interface 504 to enable communication between the frictionless shopping system 500 and network devices via a network (e.g., the internet) and/or cloud computing services, not shown.

The processor(s) 502 is further coupled to a persistent storage 506. According to one embodiment of the disclosure, the persistent storage 506 may store logic as software modules including a frictionless shopping system logic 510 and the communication interface logic 508. The operations of these software modules, upon execution by the processor(s) 502, are similar to the descriptions of the logics described above in FIG. 4. Of course, it is contemplated that some or all of this logic may be implemented as hardware, and if so, such logic could be implemented separately from each other.

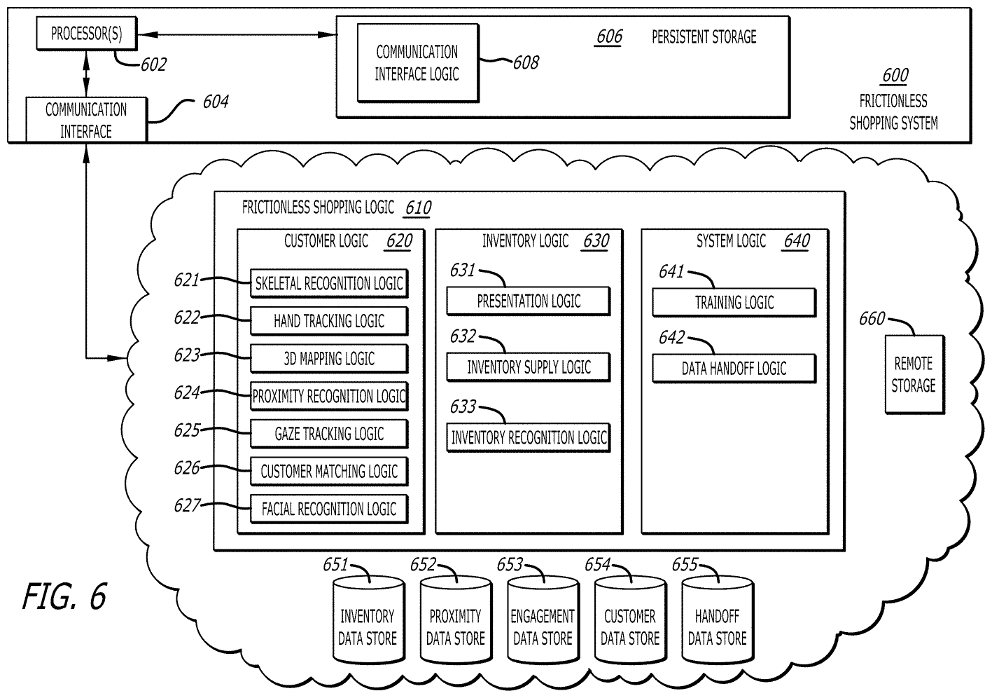

Referring to FIG. 6, a third logical representation of the frictionless shopping system 600 in accordance with some embodiments is shown. The frictionless shopping system 600 depicted is similar to the frictionless shopping system 400 of FIG. 4, however, this depicted embodiment is not directly embedded or attached to an intelligent shelf and wherein the logics and data stores utilized are remotely located apart from the frictionless shopping system 600. In certain embodiments, the frictionless shopping system 600 can be realized as a standalone device that may be physically located away from the intelligent shelving units with a communication interface 604 that can communicate with the remote frictionless shopping logic 610 and data stores 651, 652, 653, 654, 655. In further embodiments, the frictionless shopping system 600 may be realized in a device not initially configured to be a frictionless shopping system 600, but already contains the necessary components and can have the functionality necessary to become a frictionless shopping system 600 via an update such as, but not limited to, a software and/or firmware update. In this way, the frictionless shopping system 600 may be added to a pre-existing intelligent shelf system without the need to add new hardware to the intelligent shelves. The communication between the frictionless shopping system 600 and the intelligent shelves associated with the shopping areas to be processed with the communication logic 608 of the frictionless shopping system 600.

Similar to the frictionless shopping system 400 depicted in FIG. 4, the frictionless shopping system 600 may comprise one or more processors 602 that are coupled to a communication interface 604. The communication interface 604, in combination with a communication interface logic 608 stored within a persistent storage 606, enables communications with external network devices and/or other network appliances to transmit and receive data. Many embodiments may communicate with a frictionless shopping server 110 as depicted in FIG. 1 in order to communicate and process logics and utilize data stores. According to one embodiment of the disclosure, the communication interface 604 may be implemented as a physical interface including one or more ports for wired connectors. Additionally, or in the alternative, the communication interface 604 may be implemented with one or more radio units for supporting wireless communications with other electronic devices. The communication interface logic 608 may include logic for performing operations of receiving and transmitting data via the communication interface 604 to enable communication between the frictionless shopping system 600 and network devices via a network (e.g., the internet) and/or cloud computing services, not shown.

The communication interface 604 is further in communication to a remote storage 660. According to one embodiment of the disclosure, the remote storage 660 may store logic as software modules including a frictionless shopping logic 610 along with various data stores 651, 652, 653, 654, 655. The operations of these logics, upon execution by the processor(s) 602, are similar to the descriptions of the logics described above in FIG. 4. It is contemplated that some or all of this logic may be processed either remotely by a cloud/edge server. In other embodiments, the processing is done by the processor(s) 602 within the frictionless shopping system 600.

IV. Inventory Detection

Referring to FIG. 7, an illustration of an image captured by a camera of an frictionless shopping system is shown in accordance with some embodiments. The image 700 shown in FIG. 7 illustrates the ability of an inventory camera configured for use with a variety of embodiments of frictionless shopping system embodiments including the frictionless shopping system 400 depicted in FIG. 4. The inventory camera can capture the image 700 having a 180° viewing angle. In one embodiment, an inventory camera, such as the inventory camera 310₁ of FIG. 3, may be positioned within a shelving unit, such as the shelving unit 302 of FIG. 3, such that the inventory camera is located at the inner rear of the shelving unit and above a portion of inventory. In such an embodiment, the inventory camera 310₁ may capture an image such as the image 700, which includes a capture of an inventory portion 708 and an inventory portion 710 stocked on shelving 706. In addition, the image 700 may include a capture of a portion of the store environment 702 and additional inventory 712.

Specifically, the positioning of the inventory camera as shown in FIG. 7 enables the inventory camera to capture images such as the image 700, which may be analyzed by logic of the frictionless shopping system to automatically and intelligently determine a variety of information including, but not limited to, the amount of inventory stocked on the shelf, the type of inventory stocked on the shelf, the SKU of the inventory stocked on the shelf, and/or if inventory has been removed or replaced on the shelf by a customer or vendor. For example, as seen in the image 700, the inventory portion 708 and the inventory portion 710 may be identified by the frictionless shopping system using various object recognition techniques. For example, upon recognition of the inventory portion 708 (e.g., recognition of Pepsi bottles), logic of the frictionless shopping system may analyze the quantity remaining on the shelf 706. In one embodiment, the frictionless shopping system may determine whether a threshold number of bottles have been removed from the shelf 706. Upon determining at least the threshold number of bottles have been removed, the frictionless shopping system may generate a report and/or an alert notifying employees of the store that the inventory portion 708 requires restocking. In a second embodiment, the frictionless shopping system may determine that less than a threshold number of bottles remain on the shelf 706 and therefore the inventory portion 708 requires restocking. Utilization of other methodologies of determining whether at least a predetermined number of items remain on a shelf for a given inventory set are within the scope of the invention. Herein, the term “inventory set” generally refers to a grouping of a particular item, e.g., a grouping of a particular type of merchandise, which may include brand, product size (12 oz. bottle v. 2L bottle), etc.

In further embodiments, the frictionless shopping system may utilize data generated from the image 700 to help determine if a customer has removed an item from the shelf. By way of example and not limitation, and as further illustrated below in the discussion of FIGS. 10A and 10B, the frictionless shopping system may couple data regarding determined stock levels with data generated from cameras that may track and determine if the customer is holding a product and/or where that product was grabbed from. In this way, the frictionless shopping system may correlate the data of inventory location with the data related to customer location and pose to generate probability data that may be used to determine if a customer has removed a product from the shelf.

In some embodiments, the image 700 may also be analyzed to determine the remaining items of other inventory portions such as the inventory portion 706 and/or the alternative portion 712. As would be understood by those skilled in the art, the inventory cameras may be placed at various varying positions within, or coupled to, a shelving unit. The utilization of such alternative configurations may be dependent upon the type of shelving unit, the type of inventory being captured in images taken by the inventory camera and/or the positioning of inventory within the store environment (e.g., across an aisle).

Referring to FIG. 10A, an illustration of an image 1000A being processed with inventory recognition techniques captured by an inventory camera of the frictionless shopping system in accordance with some embodiments is shown. The captured image 1000A depicts a first customer 1010A with a first item of inventory 1015A in his right hand, as well as a second customer 1020A carrying a second item of inventory 1025A in his right hand. In many embodiments, the frictionless shopping system may take multiple images over time and apply image processing techniques to better identify whether a product is in a customer's hand and/or to potentially determine what the product is. It should be understandable to those skilled in the art that such identification techniques can vary and may include tools and/or techniques developed by third parties. In many embodiments, the image processing techniques generate an overall probability of confidence that can be manipulated over a period of time and images and subsequently be utilized by other logics for determination of what inventory product 1015A, 1025A was pulled off of the shelves and whether the inventory product is being carried or held by the customers 1010A, 1020A. It is contemplated that multiple cameras may be utilized to generate images from multiple angles of the same shopping area which can aid the image processing techniques by providing images of the product, even when the product may be secluded or other obfuscated by other objects including, but not limited to, the customer.

Referring to FIG. 10B, an illustration of multiple images being processed with inventory recognition techniques captured by an inventory camera of the frictionless shopping system in accordance with some embodiments. The pair of images 1000B depict a successive series of selected locations within a larger series of image captures where the frictionless shopping system has determined with a confidence level above a pre-determined threshold to be an inventory product. The examples depicted in FIG. 10B are respective captures of the inventory products being held by customers 1010A, 1020A in FIG. 10A. In the embodiment shown, the bottom image 1015B depicts a series of images that show the frictionless shopping system tracking the inventory product 1015A by the first customer 1010A. Likewise, the top image 1025B depicts a series of images that show the frictionless shopping system tracking the inventory product 1025A by the second customer 1020A.

The images shown in FIG. 10B should be understood to be selections the frictionless shopping system has made from the full image of the entire shopping area. Image processing techniques can be utilized along with various machine learning, predetermined rule sets, and/or deep convolutional neural networks to make decisions on which area of the image to focus on and analyze. The selection of an area of a larger image may then be passed to other logic that may further determine other characteristics including, but not limited to, inventory product SKU, which hand the inventory product is being held in, length of time held, and/or where the customer puts the inventory product down. It is contemplated that such techniques may also be helpful for store inventory loss tracking.

V. Customer Detection

Referring to FIG. 8A, an illustration of a three-dimensional shopping area space generated by the frictionless shopping system in accordance with some embodiments is shown. The depicted image covers an embodiment wherein the three-dimensional mapping logic has generated data representing a three-dimensional model 800A of the shopping area, along with a first customer 830A and a second customer 840A. The depicted embodiment also generates data representing the customers 830A, 840A as skeletal structures. It would be known to those skilled in the art that such skeletal structure generation is aided by the use of the skeletal recognition logic when processing the images used to represent the shopping area depicted by the three-dimensional space 800A.

Referring to FIG. 8B, an illustration of an overhead two-dimensional shopping area space generated by the frictionless shopping system in accordance with some embodiments is shown. Similar to the generated three-dimensional data shown in FIG. 8A, the data generated in FIG. 8B processes the same data to realize a two-dimensional overhead view 820B with a first shopper 830B and a second shopper 830B. In the depicted embodiment, the two-dimensional image 820B, and respective first and second shoppers 830B and 840B represent the same data as shown in FIG. 8A. Although the figures depict the same instant in a particular shopping experience, it should not be construed that this must always be the case. It is contemplated that the generation of three-dimensional and two-dimensional items may be generated separately, or by separate image capturing systems/devices within the frictionless shopping system and be utilized through comparison and/or matching to better generate data that yields a higher confidence level for further processing.

Referring to FIG. 8C, an illustration of a series of images captured by a plurality of customer recognition cameras of the frictionless shopping system in accordance with some embodiments is shown. Customer recognition cameras may be installed within the intelligent shelving devices or may be installed independently around the store. The customer recognition cameras may capture multiple angles of a given shopping area similar to the images 800C in FIG. 8C. By way of illustration, the top shopping area image 810C shows two customers 830C, 840C during a sample shopping process. The images captured from a customer recognition camera are processed to generate data related to the shopping environment. In many embodiments, the processing includes determining a skeletal structure of the customers 830C, 840C within the shopping area. As discussed above in the discussion of the customer logic 420 of FIG. 4, the frictionless shopping system may employ skeletal tracking, hand tracking, and/or gaze tracking logics when processing and analyzing the captured customer image data. It is contemplated that the customer recognition cameras can be either standard RGB cameras or depth cameras with infrared or other depth sensors.

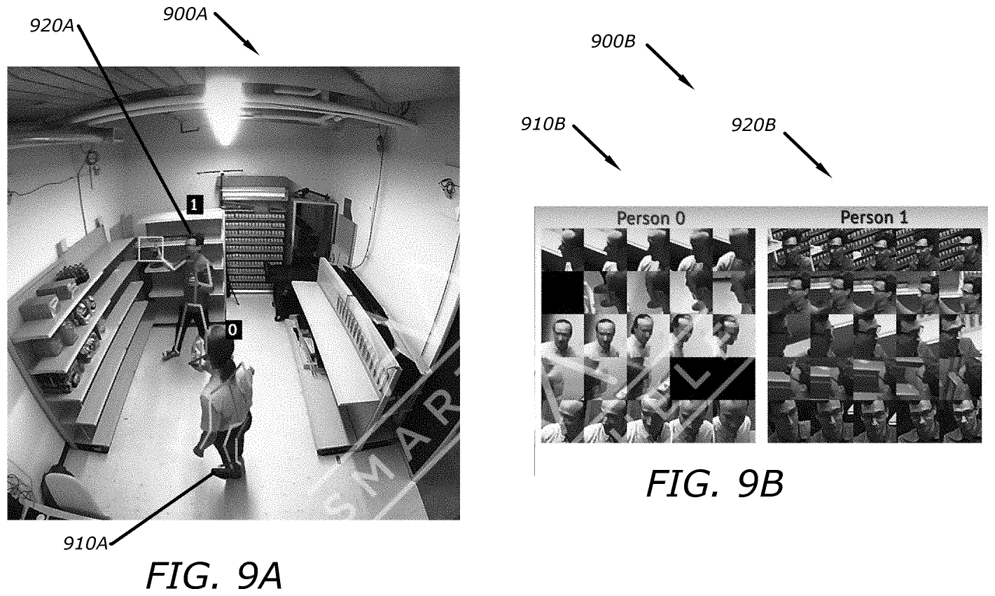

Referring to FIG. 9A, an illustration of an image 900A being processed with skeletal recognition techniques captured by a customer recognition camera of the frictionless shopping system in accordance with some embodiments is shown. In a number of embodiments, the frictionless shopping system can generate data associated with skeletal structures of customers within a shopping area. Techniques for such image processing are explained above in more detail within the discussion of skeletal recognition logic in FIG. 4. In the illustrated embodiment, a customer recognition camera captures image data from a shopping area that comprises a first customer 910A and a second customer 920A. In a number of embodiments, part of the customer recognition process comprises determining a skeletal structure that corresponds to the customer within the shopping area. Such generated skeletal data can be overlaid with the actual customer as depicted in FIG. 9A. In this way, it can be observed that the generated skeletal recognition data is an accurate representation of the customers. It is contemplated that customer recognition methods, such as skeletal recognition, can include generating confidence intervals though a variety of image processing, machine learning, predetermined rule sets, and/or deep convolutional neural networks. Similarly, those skilled in the art would recognize that such techniques may be generated through the use of third party software and methods.

Referring to FIG. 9B, an illustration of multiple images being processed with customer recognition techniques captured by a customer recognition camera of the frictionless shopping system in accordance with some embodiments is shown. As described above within the discussion of the facial recognition logic of FIG. 4, embodiments of the frictionless shopping system can process images captured from customer recognition cameras to generate facial recognition data.

The pair of images 900B depict a successive series of selected locations within a larger series of image captures wherein the frictionless shopping system has determined with a confidence level above a pre-determined threshold to be the face of a customer. The examples depicted in FIG. 9B are respective captures of the customers facial data of customers 910A, 920A as shown in FIG. 9A. In the embodiment shown, the left image 910B depicts a series of images that show the frictionless shopping system tracking the face of the first customer 910A. Likewise, the right image 920B depicts a series of images that show the frictionless shopping system tracking the face of the second customer 920A.

The images shown in FIG. 9B should be understood to be selections the frictionless shopping system has made from the full image of the entire shopping area. Image processing techniques can be utilized along with various machine learning, predetermined rule sets, and/or deep convolutional neural networks to make decisions on which area of the image to focus on and analyze. The selection of an area of a larger image may then be passed to other logic that may further determine other characteristics including, customer identification, customer demographics, gaze detection, and/or other engagement data. It is contemplated that such techniques may also be helpful for store loss prevention.

While some particular embodiments have been provided herein, and while the particular embodiments have been provided in some detail, it is not the intention for the particular embodiments to limit the scope of the concepts presented herein. Additional adaptations and/or modifications can appear to those of ordinary skill in the art, and, in broader aspects, these adaptations and/or modifications are encompassed as well. Accordingly, departures may be made from the particular embodiments provided herein without departing from the scope of the concepts provided herein.

What is claimed is:

1. A frictionless shopping system, comprising:
a plurality of intelligent shelving units, the intelligent shelving units comprising:
a plurality of inventory cameras;
a plurality of customer recognition cameras; and
at least one shelf configured to hold inventory;
one or more processors communicatively coupled to the plurality of intelligent shelving units; and
a non-transitory computer-readable medium communicatively coupled to the one or more processors and having logic thereon, the logic, when executed by the one or more processors, being configured to perform operations including:
receiving a plurality of images captured by the plurality of customer recognition cameras;
performing customer recognition techniques on the image;
determining the location of a plurality of customers within a pre-determined area;
generating customer probability data based on the customer location determination;
receiving a plurality of images captured by the plurality of inventory cameras;
performing inventory detection techniques on the image;
determining the location of a plurality of inventory products within the pre-determined area;
generating inventory probability data based on the inventory location determination; and
utilizing the customer probability data and inventory probability data to generate selection data.

2. The frictionless shopping system of claim 1, wherein the generation of selection data corresponds to the removal of a plurality of inventory products from the at least one shelf.

3. The frictionless shopping system of claim 1, wherein the frictionless shopping system further comprises:
a customer data store, wherein the customer data store comprises customer account data; and
wherein the customer recognition techniques further include matching at least one customer to customer account data associated with the customer.

4. The frictionless shopping of claim 1, wherein the frictionless shopping system further comprises:
an inventory data store, wherein the inventory data store comprises inventory price data and inventory location data.

5. The frictionless shopping of claim 3, wherein the customer data store further comprises payment information; and
in response to a pre-determined rule associated with a sale of a plurality of inventory products, the logic further processes a payment by utilizing:
customer account data; and
inventory price data.

6. The frictionless shopping of claim 1, wherein the intelligent shelving units further comprise a plurality of proximity sensors and wherein the logic further includes:
receiving a plurality of signals from the plurality of proximity sensors;
generating proximity data based on the received plurality of signals;
utilizing the proximity data in addition to customer probability data and inventory probability data to generate selection data.

7. The frictionless shopping system of claim 1, wherein the customer recognition techniques include at least one of: skeletal recognition or hand tracking.

8. The frictionless shopping system of claim 1, wherein the customer recognition techniques further includes generating data associated with a representation of a three-dimensional model of the plurality of customers within a shopping area.

9. The frictionless shopping system of claim 1, wherein the intelligent shelving units further comprises a network interface;
wherein the network interface is configured to:
connect to mobile computing devices; and
receive mobile computing device data; and
wherein the logic further utilizes the mobile computing data in addition to the customer probability data and inventory probability data to generate selection data.

10. The frictionless shopping system of claim 1, wherein the logic further utilizes the item location data in addition to the customer probability data and inventory probability data to generate selection data.

11. A computerized method, the method comprising:
receiving a plurality of images captured by a plurality of customer recognition cameras;
performing customer recognition techniques on the image;
determining the location of a plurality of customers within a pre-determined area;
generating customer probability data based on the customer location determination;
receiving a plurality of images captured by a plurality of inventory cameras;
performing inventory detection techniques on the image;
determining the location of a plurality of inventory products within the pre-determined area;
generating inventory probability data based on the inventory location determination; and
utilizing the customer probability data and inventory probability data to generate selection data.

12. The computerized method of claim 11, wherein the generation of selection data corresponds to the removal of a plurality of inventory products from at least one shelf of an intelligent shelving system.

13. The computerized method of claim 11, wherein the computerized method further comprises:
reading data from a customer data store, wherein the customer data store comprises customer account data; and
utilizing customer recognition techniques including matching at least one customer to customer account data associated with the customer.

14. The computerized method of claim 11, wherein the computerized method further comprises:
communicating with an inventory data store, wherein the inventory data store comprises inventory price data and inventory location data.

15. The computerized method of claim 13, wherein the customer data store further comprises payment information; and
in response to a pre-determined rule associated with a sale of a plurality of inventory products, the logic further processes a payment by utilizing:
customer account data; and
inventory price data.

16. The computerized method of claim 12, wherein the intelligent shelving system further comprises a plurality of proximity sensors and wherein the computerized method further includes:
receiving a plurality of signals from the plurality of proximity sensors;
generating proximity data based on the received plurality of signals;
utilizing the proximity data in addition to customer probability data and inventory probability data to generate selection data.

17. The computerized method of claim 11, wherein the customer recognition techniques include at least one of: skeletal recognition or hand tracking.

18. The computerized method of claim 11, wherein the customer recognition techniques further includes generating data associated with a representation of a three-dimensional model of the plurality of customers within a shopping area.

19. The computerized method of claim 11, wherein the intelligent shelving units further comprises a network interface;
wherein the network interface is configured to:
connect to mobile computing devices; and
receive mobile computing device data; and
wherein the logic further utilizes the mobile computing data in addition to the customer probability data and inventory probability data to generate selection data.

20. The computerized method of claim 11, wherein the logic further utilizes the item location data in addition to the customer probability data and inventory probability data to generate selection data.
